(19) United States
(12) Patent Application Publication
(10) Pub. No.: US 2011/0089276 A1
(43) Pub. Date: Apr. 21, 2011

(54) Knight shredder

(76) Inventor: Julius Richmond Jiggetts, IV, Atlanta, GA (US)

(21) Appl. No.: 12/589,092

(22) Filed: Oct. 19, 2009

(51) Int. Cl. B02C 23/00

(52) U.S. Cl. 241/101.2

(57) ABSTRACT

A paper shredder capable of Knighting (Blacking Out) documents making them illegible and then shredding document preventing document from being pieced back together and read. Feeding tray for feeding documents into machine, feed rollers, conveyor rollers, and separating rollers compose of forward and reverse rollers for transporting documents within the Knight Shredder, timing roller for synchronizing flow of documents, photosensitive drum for laying toner to documents, transfer charger for transferring toner by corona discharge, paper separating charger for separating document from drum, conveyor belt for transporting document, fixing unit, for melting toner to document, discharge roller for discharging document, conveyor belt for transporting document to shredder, paper shredder device, for shredding document, cleaner for removing residual toner, and the main eraser for erasing residual charge.

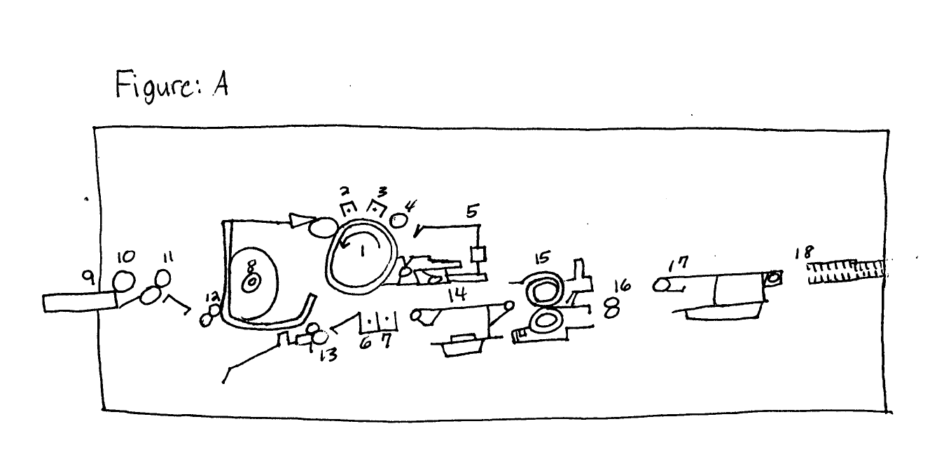

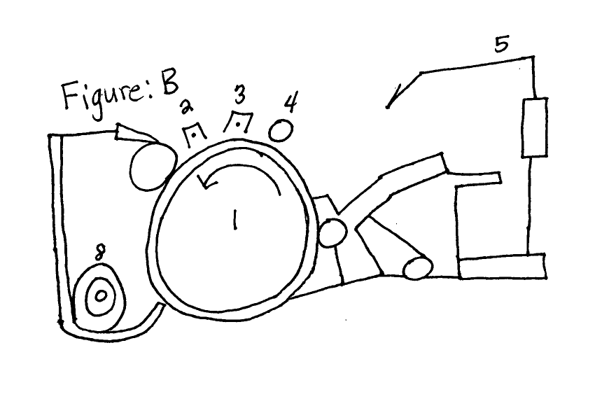

### CROSS REFERENCE TO RELATED APPLICATIONS

This application is a continuation with application Ser. No. 12/589,092 filed on Oct. 19, 2009.

### BACKGROUND OF THE INVENTION

The present invention relates to a shredding machine, and, more specifically, to a shredding machine being capable of reliably shredding documents that can not later be pieced together and legible, by Knighting (blacking out) the document in its entirety prior to shredding, which provides double protection at a low cost.

### DISCUSSION OF THE BACKGROUND

In operating the shredding machine there are three types, ranging in expense from least to greatest (1) the strip cut shredder in which the shredder shreds the document in approximately ⅛ and ¼ inch strips, however these strips can be pieced back together (2) The cross cut shredder in which the shredder shreds the document into particles, offer some more security but are much higher in price. (3) The Micro cut shredder in which the shredder shreds the document into dust, that as we know, are not able to be pieced back together, respectively, this type of shredder is priced exceedingly for the average consumer, primarily being procured by large corporations and government facilities.

### (PROBLEM TO BE SOLVED BY INVENTION)

Due to a common criminal's access of today's technology, there has been a rise in identity theft, where criminals are becoming more relentless in their endeavors to continue and expand their activity by taking the shredded pieces of documents that have been discarded by businesses, banks, and homes and piecing them back together. Once these documents are pieced back together they are legible. Now important information such as social security numbers, bank account numbers, and other private information can be obtained.

### SUMMARY OF INVENTION

Accordingly, the present invention has been made in view of the foregoing problems of the conventional paper shredder. It is an objective of the present invention to provide a paper shredder capable of preventing these problems and providing more security in shredding documents through blacking out of the documents (Knighting), when the Knighting unit is incorporated into any of the four types of paper shredders.

### BRIEF DESCRIPTION OF DRAWINGS

Figure A shows an inside view of all the various components of the invention working together in their constructed order.

Figure B shows a close view of the Knighting Unit and its components.

### DETAILED EXPLANATION OF FIGURE A THE KNIGHT SHREDDER

The Knight Shredder allows for documents to be accommodated in an upper stage feed unit of the tray type(9) and fed from it. The paper feed unit is provided with feed rollers(10) and separating rollers(11) each composed of a forward roller and reverse roller. A document fed from the paper feed unit is fed through conveyor rollers(12) to a timing roller(13) provided immediately before the Knighting Unit. The document temporarily stands by here until it is sent out to a transfer section, when the timing roller(13) is turned on in synchronization with the developing device(8) toner is formed on the photosensitive drum(1). The document is brought into close contact with the photosensitive drum(1) in the transfer section, where a blanket of toner is transferred by corona discharge from the transfer charger(6) and then the document is separated from the photosensitive drum by the corona discharge from the paper separating charger(7) and by the sturdiness of the sheet itself Thereafter, the document is fed through a conveyor belt(14) to a fixing unit(15), where toner is fixed, and the document is discharged through a conveyor roller and discharge roller(16) on to a conveyor belt(17) and fed through the paper shredder(18). Meanwhile, the photosensitive drum(1) continues rotating counterclockwise even after the transfer process, under which the photosensitive drum has residual toner removed therefrom by the cleaner(5) and the residual charge erased by the main eraser(4) thus being ready for the next Knighting process.

### DETAILED EXPLANATION OF FIGURE B SHREDDER KNIGHTING UNIT

Figure A shows a close view of the Knighting Unit and its components. The center cylinder shaped object is the photosensitive drum that is coated with a material that can hold an electrical charge. To the left of the photosensitive drum is the developing device which coats the drum with toner. To the right is the cleaning device of the blade type that cleans residual toner off of the drum.

Above the drum are the auxiliary charger which charges the drum, main eraser lamp, and auxiliary eraser lamp which helps in erasing residual toner.

What is being claimed is:

1. A paper shredder capable of Knighting (Blacking out) documents making them illegible and then shredding document preventing document from being pieced back together and read.

2. The Knight Shredder allows for documents to be accommodated in an upper stage feed unit of the tray type and fed from it, the paper feed unit is provided with feed rollers and separating rollers each composed of a forward roller and reverse roller.

3. A document fed from the paper feed unit is fed through conveyor rollers to a timing roller provided immediately before the knight out unit, the document temporarily stands by here until it is sent out to a transfer section, when the timing roller is turned on in synchronization with the developing device, toner is formed on a photosensitive drum. The document is brought into close contact with the photosensitive drum in the transfer section, where a blanket of toner is transferred by corona discharge from the transfer charger.

4. The document is separated from the photosensitive drum by the corona discharge from the paper separating charger and by the sturdiness of the sheet itself. Thereafter, the document is fed through a conveyor belt to a fixing unit, where toner is fixed (heated and dried on to document) and the document is discharged through a conveyor roller and discharge roller on to a conveyor belt and then fed through shredding blades.

5. Meanwhile, the photosensitive drum continues rotating counterclockwise even after the transfer process, under which the photosensitive drum has residual toner removed therefrom by the cleaner and the residual charge erased by the main eraser thus being ready for the next knighting process.
